(19) United States
(12) Patent Application Publication
(10) Pub. No.: US 2005/0206571 A1
(43) Pub. Date: Sep. 22, 2005

(54) High frequency switch circuit

(75) Inventor: Tsutomu Takenaka, Hachioji-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/079,821

(22) Filed: Mar. 15, 2005

(30) Foreign Application Priority Data
Mar. 18, 2004 (JP) 2004-077441

(51) Int. Cl. H01Q 9/00

(52) U.S. Cl. 343/745

(57) ABSTRACT

A transmission line is inserted and connected between each two adjacent switching elements connected in series. The total of the amount of transmission characteristic phase change of each transmission line, and the amount of reflection characteristic phase change caused by a parasitic capacitance in an OFF state in each switching element is set approximately equal to 90 degrees at the upper limit of using frequency. According to this configuration, a filter having a pass band at twice the using frequency is constructed so that the signal is cut off at the using frequency. This improves the leakage suppression characteristics. Further, the impedance of each transmission line is set equal to the input-output characteristic impedance of the circuit. This minimizes an additional insertion loss caused by the insertion of the transmission lines.

### BACKGROUND OF THE INVENTION

1. Field of the Invention

The present invention relates to the structure of a high frequency switch circuit for switching the path of a high frequency electric signal in a circuit apparatus for processing the high frequency electric signal.

2. Prior Art

With the spread of portable personal computers and personal digital assistants, a consumer demand is rapidly increasing for wireless network interface cards employing high frequencies. And so is a consumer demand for high frequency cordless phones aiming at high communication quality. Here, it should be noted that these demands are followed by additional market demand for size reduction and advanced functions. In these devices, high frequency switch circuits achieve the functions of transmission/reception change, antenna diversity, band change in multi band systems, and the like. Conditions required in these high frequency switch circuits include: low insertion loss in the ON state; high leakage suppression in the OFF state; high reliability, that is, resistance to electrostatic discharge; low price; and small size.

FIG. 10 is a circuit diagram of a practically used high frequency switch circuit of single pole double throw type. In this high frequency switch circuit, switching elements 1 and 2 composed of field effect transistors in series in two stages are inserted and connected to a signal path between terminals 31 and 32, while switching elements 3 and 4 composed of field effect transistors in series in two stages are inserted and connected to a signal path between terminals 31 and 33. Turning ON and OFF of the switching elements 1 and 2 is controlled by a voltage applied to a control terminal 35. Turning ON and OFF of the switching elements 3 and 4 is controlled by a voltage applied to a control terminal 36. Numerals 5-8 indicate high resistance elements.

In this high frequency switch circuit, in the ON-side signal path (the signal path between the terminals 31 and 33, in the following example), a gate bias is provided from the control terminal 36 to the switching elements 3 and 4 so that the switching elements 3 and 4 are biased into an ON region and thereby have a low resistance. On the other hand, in the OFF-side signal path (the signal path between the terminal 31 and the terminal 32, in this example), a gate bias is provided from the control terminal 35 to the switching elements 1 and 2 so that the switching elements 1 and 2 are biased into an OFF region and thereby have a high resistance. The ON-side signal path and the OFF-side signal path are interchanged when the gate biases provided to the control terminals 35 and 36 are interchanged.

In some cases, the number of stages in the series connection of the switching elements is increased into three, four, or the like. This structure has a consumer market-oriented advantage that the size and the price are reduced while the resistance to electrostatic discharge is maintained.

Nevertheless, in the OFF-side signal path, a parasitic capacitance remains in each of the switching elements 1 and 2 biased into the OFF region. This results in a configuration that the parasitic capacitances are connected in series to the path. This causes a disadvantage of degrading the OFF leakage suppression characteristics.

FIG. 11 shows an equivalent circuit in which the switching elements 1, 2, 3, and 4 of FIG. 10 are replaced by resistances and capacitances. In FIG. 11, capacitances 21 and 22 correspond to the parasitic capacitances in the switching elements 1 and 2 biased into the OFF region. Resistances 23 and 24 correspond to the ON resistances of the switching elements 3 and 4 in the ON state.

Here, the high resistance components present in parallel to the parasitic capacitances have an extremely large value which can be considered to be infinite. Thus, the high resistance components are not shown in the figure. The capacitances 21 and 22 are usually in a value from a few hundred fF to a few pF. When the capacitances 21 and 22 are assumed to be 0.5 pF each, their series capacitance becomes 0.25 pF. The impedance becomes approximately 130 ohms at 5 GHz. Thus, the leakage suppression becomes 12 dB which is not sufficient.

In order to resolve this problem, a method has been invented that the transmission line length between adjacent switching elements is set to be an odd multiple of ¼ wavelength. Nevertheless, in a frequency range where parasitic capacitances are not negligible, the odd multiple of ¼ wavelength is not sufficiently optimal and needs improvement. On the other hand, in a frequency range where parasitic capacitances are negligible, the leakage caused by the parasitic capacitances is itself small. Thus, the advantage in the transmission line is small.

Patent document 1: JP-A-H53-136952

As described above, in the prior art high frequency switch circuit in which switching elements are connected in series in multistage, there has been a problem that the leakage suppression characteristics is not sufficient in a signal path where the switching elements are OFF.

### SUMMARY OF THE INVENTION

An object of the invention is to provide a high frequency switch circuit in which sufficient leakage suppression characteristics is obtained in a signal path where switching elements are OFF.

In order to achieve this object, a high frequency switch circuit according to the invention comprises: a plurality of switching elements provided in series connection in each signal path; and transmission lines each inserted and connected between adjacent ones of a plurality of the switching elements; wherein the total of the amount of transmission characteristic phase change per each transmission line and the amount of reflection characteristic phase change caused by a parasitic capacitance in an OFF state per each switching element is approximately equal to an odd multiple of the phase change of 90 degrees at a wavelength corresponding to an upper limit of using frequency.

According to this configuration, a leakage signal that leaks through a signal path where the switching elements are OFF has a phase different by approximately 180 degrees from that of a reflected signal of the leakage signal at a wavelength corresponding to the upper limit of using frequency. Thus, both signals cancel out so that sufficient leakage suppression characteristics is obtained in the signal path where the switching elements are OFF.

Further, the adding of the transmission lines causes merely a minimum increase in the number of components, and still achieves the above-mentioned object of improving the leakage suppression characteristics in the OFF state while an adverse influence is minimized on the insertion loss in the ON state.

The characteristic impedance of the transmission lines is preferably equal to the input-output characteristic impedance. This minimizes an additional insertion loss caused by the insertion of the transmission lines.

The length of each transmission line is adjusted in a preferred embodiment in order that the total of the amount of transmission characteristic phase change per each transmission line and the amount of reflection characteristic phase change caused by a parasitic capacitance in an OFF state per each switching element should approximately be equal to an odd multiple of 90 degrees at the upper limit of using frequency.

Each switching element may be a field effect transistor, a bipolar transistor, or a diode.

When such a switching element is employed, the active layer area of the field effect transistor, the bipolar transistor, or the diode, the gate width of the field effect transistor, or the emitter size of the bipolar transistor may be adjusted in place or addition of the above-mentioned adjustment method in order that the total of the amount of transmission characteristic phase change per each transmission line and the amount of reflection characteristic phase change caused by a parasitic capacitance in an OFF state per each switching element should approximately be equal to an odd multiple of 90 degrees at the upper limit of using frequency.

In this high frequency switch circuit, in a preferred embodiment, the switching elements and the transmission lines are integrally formed as an integrated circuit on a semiconductor substrate.

In this high frequency switch circuit, the switching elements may be integrally formed as an integrated circuit on a semiconductor substrate. Further, the transmission lines may be formed on a ceramic substrate or a resin substrate on which the semiconductor substrate is mounted, or alternatively in a ceramic package or a resin package in which the semiconductor substrate is mounted. Then, the switching elements and the transmission lines may be interconnected electrically.

Each transmission line may be composed of a microstrip line, a coplanar waveguide line, a coplanar waveguide line with ground plane, a slotted line, a slotted line with ground plane, a suspension type microstrip line, a spiral shaped strip line, a meander shaped strip line, a metal-wire constructed strip line, a multilayer thin film strip line, a multilayer thin film strip line with ground plane, or a combination of these.

As described above, in the high frequency switch circuit according to the invention, a parasitic capacitance of each switching element in the OFF state is taken into consideration so that the total of the amount of transmission characteristic phase change per each transmission line between adjacent switching elements and the amount of reflection characteristic phase change caused by a parasitic capacitance per each switching element in the OFF state is set approximately equal to ¼ or its odd multiple of the wavelength at the upper limit of using frequency of the switching circuit, that is, an odd multiple of 90 degrees.

According to this configuration, when the switching elements are OFF, a band pass type filter is constructed that has a pass band at twice the frequency of the upper limit of using frequency of the high frequency switch circuit. As a result, the using frequency band of the high frequency switch circuit falls within the cut off frequency range. Thus, the leakage suppression characteristics improved by approximately 4-8 dB per one stage of the series connection in comparison with the case that the transmission line is not employed.

On the other hand, when the switching elements are ON, the impedance of each transmission line is equal to the input-output characteristic impedance of the high frequency switch circuit. This minimizes an additional insertion loss caused by the insertion of the transmission line. Specifically, the additional insertion loss is as low as a few tenths dB.

### BRIEF DESCRIPTION OF THE DRAWINGS

FIG. 1 is a schematic perspective view showing the configuration of a high frequency switch circuit according to Embodiment 1 of the invention.

FIG. 2 is a circuit diagram showing the configuration of a high frequency switch circuit according to Embodiment 1 of the invention.

FIG. 3 is an equivalent circuit diagram of a high frequency switch circuit according to Embodiment 1 of the invention.

FIG. 4 is a graph showing calculated values for the insertion loss characteristics and the leakage loss characteristics of Embodiment 1 of the invention.

FIG. 5 is a graph showing the phase characteristics of a parasitic capacitance in the case that switching elements of FIG. 1 according to Embodiment 1 are OFF.

FIG. 6 is a graph showing the phase characteristics of a transmission line of FIG. 1 according to Embodiment 1.

FIG. 7 is a schematic perspective view showing the configuration of a high frequency switch circuit according to Embodiment 2 of the invention.

FIG. 8 is a circuit diagram showing the configuration of a high frequency switch circuit according to Embodiment 2 of the invention.

FIG. 9 is a graph showing the insertion loss characteristics and the leakage suppression characteristics in two cases that transmission lines are employed and not employed in a high frequency switch circuit according to Embodiment 2 of the invention.

FIG. 10 is a circuit diagram showing the configuration of a prior art high frequency switch circuit of single pole double throw type.

FIG. 11 is an equivalent circuit diagram of a high frequency switch circuit of FIG. 10.

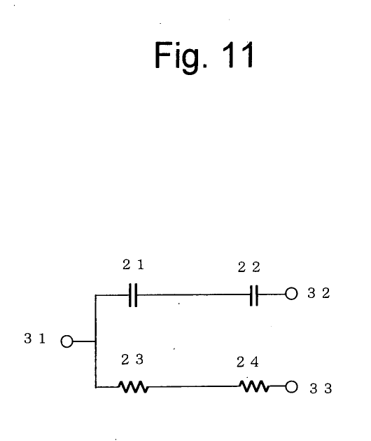

### DESCRIPTION OF THE PREFERRED EMBODIMENTS

Embodiments of the invention are described below with reference to the drawings.

### EMBODIMENT 1

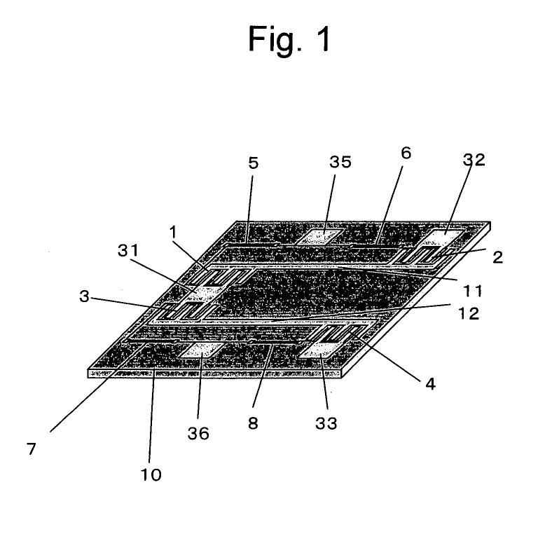

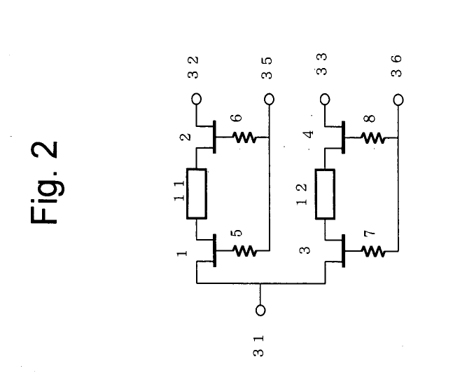

FIG. 1 is a schematic perspective view showing the configuration of a high frequency switch circuit according to Embodiment 1 of the invention. This high frequency switch circuit achieves a single pole double throw switch function. FIG. 2 is a circuit diagram showing the configuration of the high frequency switch circuit.

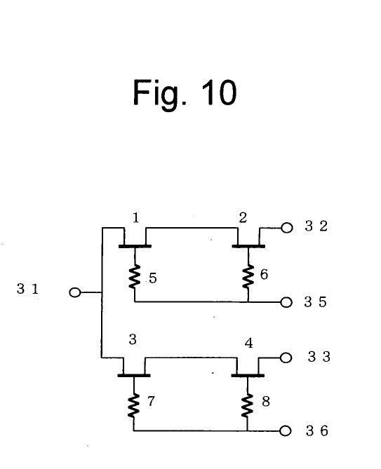

In the high frequency switch circuit, switching elements 1-4 are the same as those of FIG. 10, and composed of four field effect transistors formed on a semi-insulating GaAs substrate 10. A transmission line 11 is inserted and connected between the switching elements 1 and 2, while a transmission line 12 is inserted and connected between the switching elements 3 and 4.

For example, a zero bias is applied from a control terminal 35 through high resistance elements 5 and 6 to the switching elements 1 and 2 so that these switching elements are in the OFF state. Further, a positive bias is applied from a control terminal 36 through high resistance elements 7 and 8 to the switching elements 3 and 4 so that these switching elements are in the ON state. In this situation, the path between a terminal 31 and a terminal 32 is OFF, while the path between the terminal 31 and a terminal 33 is ON. In simple words, this high frequency switch circuit is constructed such that the switching elements 1-4 and the transmission lines 11 and 12 are integrally formed as an integrated circuit on the semiconductor substrate 10.

Each of the transmission lines 11 and 12 is composed of a microstrip line, a coplanar waveguide line, a coplanar waveguide line with ground plane, a slotted line, a slotted line with ground plane, a suspension type microstrip line, a spiral shaped strip line, a meander shaped strip line, a metal-wire constructed strip line, a multilayer thin film strip line, a multilayer thin film strip line with ground plane, or a combination of these.

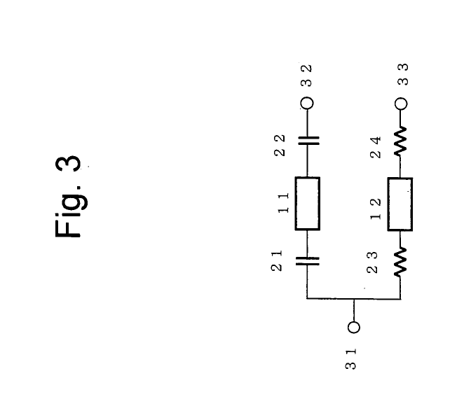

FIG. 3 is an equivalent circuit diagram of the high frequency switch circuit in the case that the path between the terminal 31 and the terminal 32 is OFF while the path between the terminal 31 and the terminal 33 is ON. FIG. 3 is an equivalent circuit diagram where the switching elements 1, 2, 3, and 4 of FIG. 2 are replaced by capacitances 21 and 22 and resistances 23 and 24. The capacitances 21 and 22 correspond to the switching elements 1 and 2, while the resistances 23 and 24 correspond to the switching elements 3 and 4. The high resistance components in the switching elements 1 and 2 in the OFF state are sufficiently larger than the impedances of the capacitances 21 and 22 in a high frequency range. Thus, these component paths can be regarded as open, and hence are not shown in the figure.

Here, the switching elements 1 and 2 in the OFF state have a high resistance from a few tens kilo-ohms to a mega-ohm or the like. At the same time, a parasitic capacitance remains which results from their structure. On the other hand, in the switching elements 3 and 4 in the ON state, a resistance remains in a range from a few hundred milliohms to a few ohms or the like. When the biases from the control terminals 35 and 36 are interchanged, the ON and OFF states of the switching elements 1 and 2 and the switching elements 3 and 4 are reversed.

As described above, the transmission lines 11 and 12 are arranged respectively between the adjacent switching elements 1 and 2 and between the adjacent switching elements 3 and 4. The line width of the transmission lines 11 and 12 is adjusted such as to have an impedance matched with the input-output characteristic impedance. The line length of the transmission lines 11 and 12 is set such that the total of the amount of transmission characteristic phase change in each of the transmission lines 11 and 12 and the amount of reflection characteristic phase change caused by each of the parasitic capacitances 21 and 22 should approximately be equal to 90 degrees at the upper limit of using frequency of the high frequency switch circuit. The amount of reflection characteristic phase change caused by each of the parasitic capacitances 21 and 22 in this case is defined as such a value that one side of the capacitance is terminated with the characteristic impedance and then the impedance concerned is measured on the opposite side. When the upper limit of using frequency of the high frequency switch circuit is converted into a wavelength, the total amount of the phase changes corresponds approximately to ¼ wavelength.

A majority of a signal having leaked through the parasitic capacitance 21 is reflected by the parasitic capacitance 22. The phase advances by ½ wavelength during the round trip so that the reflected signal is composed with the leaked input signal in the opposite phase. Thus, the transmission line and the parasitic capacitance show a shunt effect. This effect suppresses the leakage. In other words, a filter having a pass band at twice the frequency of the upper limit of using frequency of the switching circuit is constructed between the terminal 31 and the terminal 32 on the OFF side. That is, a cut off region of the filter extends over the upper limit of using frequency of the switching circuit so that the leakage suppression characteristics is enhanced.

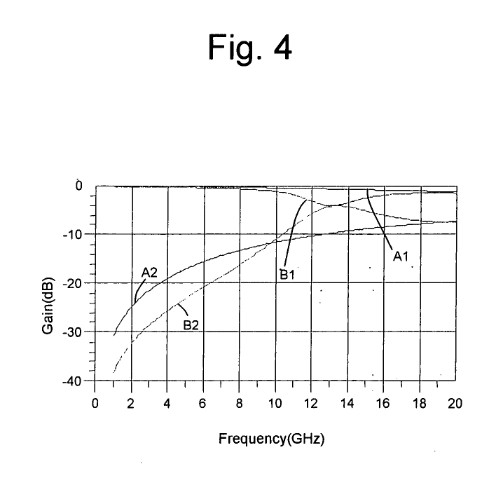

FIG. 4 shows a simulation result of the frequency characteristics of the insertion loss and the leakage suppression with the upper limit of using frequency of 6 GHz in two cases that the transmission lines 11 and 12 are employed and not employed. Curves A1 and A2 indicate the frequency characteristics of the insertion loss and the leakage suppression, respectively, in the case that the transmission lines 11 and 12 are not employed. Curves B1 and B2 indicate the frequency characteristics of the insertion loss and the leakage suppression, respectively, in the case that the transmission lines 11 and 12 are employed. The data shows that the leakage suppression characteristics is improved by 4-5 dB at or below the using frequency of 6 GHz.

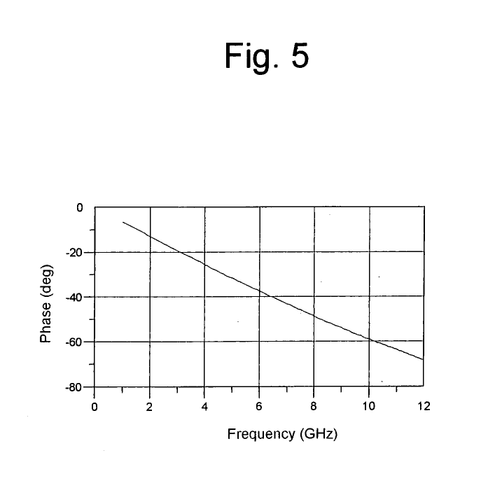

In FIG. 3, the parasitic capacitances 21 and 22 are 0.18 pF each, in an example. FIG. 5 shows the reflection characteristic phase change in a parasitic capacitance of 0.18 pF in the state that one side is terminated with 50 ohms. A phase change of approximately 38 degrees is observed at a frequency of 6 GHz.

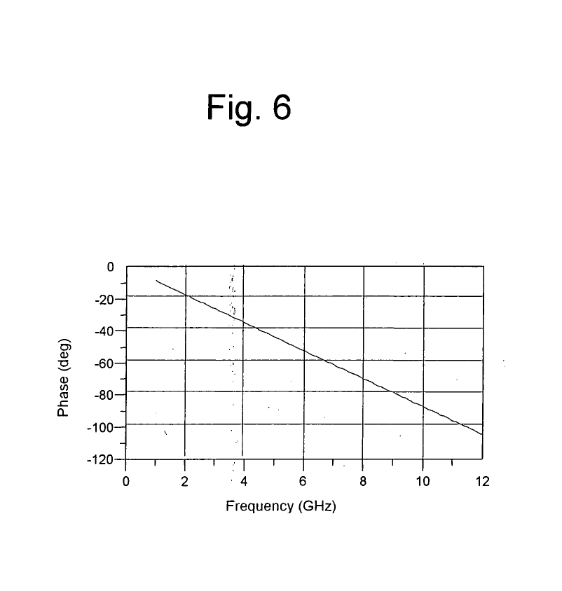

In FIG. 1, on the 100-μm thick gallium arsenide substrate with a ground plane on the back side, the transmission lines 11 and 12 are constructed as microstrip lines each having a characteristic impedance of 50 ohms which is equal to the input-output characteristic impedance. In an example, their line width is 80 μm, while each length is 2.6 mm. FIG. 6 shows the characteristics of the transmission characteristic phase change per each transmission line. When the length of the transmission line is 2.6 mm, a transmission characteristic phase change of approximately 52 degrees occurs at a frequency of 6 GHz.

According to this setup, the total of the amount of reflection characteristic phase change of the parasitic capacitance and the amount of transmission characteristic phase change of the transmission line is set approximately equal to 90 degrees, that is, ¼ wavelength. The insertion loss between the terminal 31 and the terminal 33 in the ON state is degraded by the conductor loss and the dielectric loss in the transmission lines 11 and 12. However, the amount of degradation is as small as 0.3 dB at 6 GHz.

In the above-mentioned embodiment, field effect transistors have been used as the switching elements. However, the invention is not limited to this configuration. Bipolar transistors may be used.

In the configuration of the above-mentioned embodiment, the length of the transmission line has been changed in order to adjust the amount of phase change. However, the active layer area of the switching element, the gate width of the field effect transistor, or the emitter size of the bipolar transistor may instead be changed in order to adjust the value of the parasitic capacitance.

According to this embodiment, a leakage signal that leaks through a signal path where the switching elements are OFF has a phase different by approximately 180 degrees from that of a reflected signal of the leakage signal at a wavelength corresponding to the upper limit of using frequency. Thus, both signals cancel out so that sufficient leakage suppression characteristics is obtained in the signal path where the switching elements are OFF.

### EMBODIMENT 2

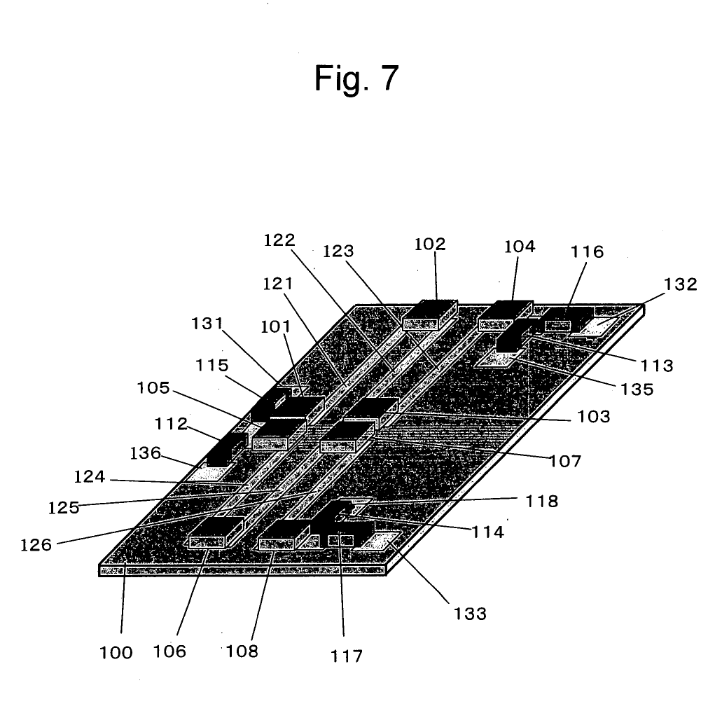

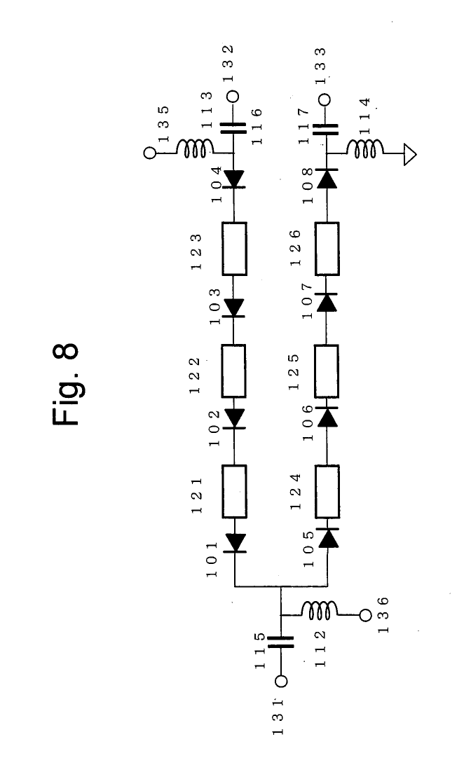

FIG. 7 is a schematic perspective view showing the configuration of a high frequency switch circuit according to Embodiment 2 of the invention. This high frequency switch circuit achieves a single pole double throw switch function. FIG. 8 is a circuit diagram showing the configuration of the high frequency switch circuit.

In the high frequency switch circuit, each of switching elements 101-108 is composed of a resin sealed PIN diode. The switching elements 101-108 are arranged on an alumina substrate 100 (specific dielectric constant is 9.6). Each of transmission lines 121-126 is arranged between each adjacent ones of the switching elements 101-108. A positive bias is applied to a bias terminal 135 in advance. This positive bias is applied through a choke coil 113 to the switching element 104. A choke coil 114 provides a zero bias to the switching element 108 through a via hole 118.

Then, when a positive bias is applied from a control terminal 136 through a choke coil 112 to the switching elements 101 and 105, the switching elements 101-104 go OFF, while the switching elements 105-108 go ON. That is, the path between an input terminal 131 and an output terminal 132 goes OFF, while the path between the input terminal 131 and an output terminal 133 goes ON. Each of capacitive elements 115, 116, and 117 cuts the bias, and hence transmits solely the signal component between the input terminal 131 and the first output terminal 132 or the second output terminal 133. Here, when a zero bias is provided from the control terminal 136 through the choke coil 112 to the switching elements 101 and 105, the switching elements 101-104 go ON, while the switching elements 105-108 go OFF. Thus, the path between the input terminal 131 and the first output terminal 132 goes ON, while the path between the input terminal 131 and the second output terminal 133 goes OFF.

As described above, each of the transmission lines 121-126 is arranged between each adjacent ones of the switching elements 101-108. Similarly to Embodiment 1, the length of each of the transmission lines 121-126 is set such that the total of the amount of transmission characteristic phase change per each transmission line and the amount of reflection characteristic phase change caused by a parasitic capacitance per each switching element in the OFF-biased state should approximately be equal to 90 degrees at the upper limit of using frequency of the high frequency switch circuit. Here, the amount of reflection characteristic phase change caused by the parasitic capacitance in each of the OFF-state switching elements 102 and 103 (or 106 and 107) in the intermediate stages is estimated in a one-side grounded state. The amount of reflection characteristic phase change caused by the parasitic capacitance in each of the OFF-state switching elements 101 and 104 (or 105 and 108) in the end stages is estimated such that one side of the capacitance is grounded through the characteristic impedance and then the impedance concerned is measured on the opposite side.

In simple words, in the configuration of this high frequency switch circuit, the switching elements 101-108 are integrally formed as an integrated circuit on a semiconductor substrate (chip). Then, the transmission lines 121-126 are formed on a ceramic substrate or a resin substrate on which the semiconductor substrate is mounted. Alternatively, the transmission lines 121-126 are formed in a ceramic package or a resin package in which the semiconductor substrate is mounted. Further, the switching elements 101-108 and the transmission lines 121-126 are interconnected electrically.

Each of the transmission lines 121-126 is composed of a microstrip line, a coplanar waveguide line, a coplanar waveguide line with ground plane, a slotted line, a slotted line with ground plane, a suspension type microstrip line, a spiral shaped strip line, a meander shaped strip line, a metal-wire constructed strip line, a multilayer thin film strip line, a multilayer thin film strip line with ground plane, or a combination of these.

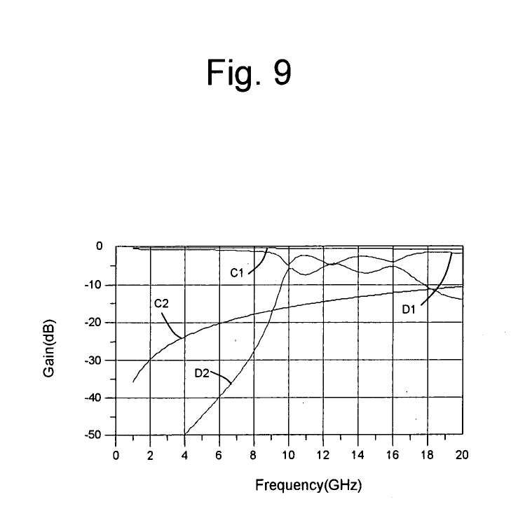

FIG. 9 shows a simulation result of the frequency characteristics of the insertion loss and the leakage suppression in two cases that the transmission lines 121-126 are employed and not employed. Curves C1 and C2 indicate the frequency characteristics of the insertion loss and the leakage suppression, respectively, in the case that the transmission lines 121-126 are not employed. Curves D1 and D2 show the frequency characteristics of the insertion loss and the leakage suppression, respectively, in the case that the transmission lines 121-126 are employed. The data shows that the leakage suppression characteristics is greatly improved into approximately 20 dB at 6 GHz which is the upper limit of using frequency.

In FIG. 8, the remnant OFF parasitic capacitance in each of the switching elements 101-104 is 0.2 pF. On the 100-μm thick gallium arsenide substrate with a ground plane on the back side, the transmission lines 121-126 are constructed as microstrip lines each having a characteristic impedance of 50 ohms. Thus, each microstrip line ahs a line width of 118 μm and a length of 3.2 mm. The insertion loss in the ON state is degraded by the conductor loss and the dielectric loss in the transmission lines. However, the amount of degradation is as small as approximately 0.5 dB at 6 GHz.

According to this embodiment, a leakage signal that leaks through a signal path where the switching elements are OFF has a phase different by approximately 180 degrees from that of a reflected signal of the leakage signal at a wavelength corresponding to the upper limit of using frequency. Thus, both signals cancel out so that sufficient leakage suppression characteristics is obtained in the signal path where the switching elements are OFF.

In the above-mentioned embodiment, in order to adjust the amount of phase change, the length of the transmission line may be changed. Alternatively, the active layer area of the diode serving as the switching element may be changed so as to adjust the value of the parasitic capacitance.

Embodiments 1 and 2 have been described for the case of a switch having a single pole double throw switch function. However, the invention is similarly applicable to: a double pole double throw switch constructed from a plurality of switching elements connected in series; a single pole single throw switch; a multi port switch such as a single pole triple or more throw switch; and a matrix switch of multi pole multi throw.

### INDUSTRIAL APPLICABILITY

The invention is useful as a switching circuit that is used in a microwave front end circuit or a microwave wireless communication device or terminal such as a wireless LAN network device, a cordless phone, an ETC(electronic toll collection system), and a portable phone and thereby used for transmission/reception change, antenna selection in antenna diversity, or filter or oscillator change in multi band configuration.

Further, the invention is expected to have a great advantage in a switching circuit that is integrally formed on a semiconductor substrate and processes a microwave of especially 5 GHz or higher. Furthermore, the invention is expected to have a great advantage in a switching circuit that is integrally formed on a ceramic substrate or an LTCC (Low Temperature Co-fired Ceramics) substrate and processes a microwave of especially 5 GHz or higher.

1. A High frequency switch circuit comprising: a plurality of switching elements provided in series connection in each signal path; and transmission lines each inserted and connected between adjacent ones of a plurality of said switching elements; wherein the total of the amount of transmission characteristic phase change per each of said transmission lines and the amount of reflection characteristic phase change caused by a parasitic capacitance in an OFF state per each of said switching elements is approximately equal to an odd multiple of the phase change of 90 degrees at a wavelength corresponding to an upper limit of using frequency.

2. A high frequency switch circuit according to claim 1, wherein a characteristic impedance of each of said transmission lines is equal to an input-output characteristic impedance.

3. A high frequency switch circuit according to claim 1, wherein each of said switching elements is composed of a field effect transistor, a bipolar transistor, or a diode.

4. A high frequency switch circuit according to claim 1, wherein a length of each of said transmission lines is adjusted in order that the total of the amount of transmission characteristic phase change per each of said transmission lines and the amount of reflection characteristic phase change caused by a parasitic capacitance in an OFF state per each of said switching elements should approximately be equal to an odd multiple of 90 degrees at an upper limit of using frequency.

5. A high frequency switch circuit according to claim 3, wherein an active layer area of said field effect transistor, said bipolar transistor, or said diode, a gate width of said field effect transistor, or an emitter size of said bipolar transistor is adjusted in order that the total of the amount of transmission characteristic phase change per each of said transmission lines and the amount of reflection characteristic phase change caused by a parasitic capacitance in an OFF state per each of said switching elements should approximately be equal to an odd multiple of 90 degrees at an upper limit of using frequency.

6. A high frequency switch circuit according to claim 1, wherein said switching elements and said transmission lines are integrally formed as an integrated circuit on a semiconductor substrate.

7. A high frequency switch circuit according to claim 1, wherein: said switching elements are integrally formed as an integrated circuit on a semiconductor substrate; said transmission lines are formed on or in a ceramic substrate, a resin substrate, a ceramic package, or a resin package where said semiconductor substrate is mounted; and said switching elements and said transmission lines are interconnected electrically.

8. A high frequency switch circuit according to claim 1, wherein each of said transmission lines is composed of a microstrip line, a coplanar waveguide line, a coplanar waveguide line with ground plane, a slotted line, a slotted line with ground plane, a suspension type microstrip line, a spiral shaped strip line, a meander shaped strip line, a metal-wire constructed strip line, a multilayer thin film strip line, a multilayer thin film strip line with ground plane, or a combination of these.
